(19) United States
(12) Patent Application Publication
(10) Pub. No.: US 2023/0112026 A1
(43) Pub. Date: Apr. 13, 2023

(54) ANIMAL MASSAGER

(71) Applicant: Douglas Scott Polack, Granville, OH (US)

(72) Inventor: Douglas Scott Polack, Granville, OH (US)

(21) Appl. No.: 17/496,233

(22) Filed: Oct. 7, 2021

(51) Int. Cl. A61H 7/00; A01K 13/00

(52) U.S. Cl. CPC A61H 7/003; A01K 13/00; A61H 2201/0153; A61H 2203/03

(57) ABSTRACT

An animal massager for stimulating a pet animal, such as a house cat, is disclosed. In a particular version, the animal massager is ideally suited to gently engage, massage, and stimulate cat whiskers and the surrounding tissue located at the base of the whiskers by contacting the animal with one or more protrusions and surfaces. In a version, the animal massager generally comprises an elongated handle and a head portion affixed to an end of the elongated handle. The head portion may include a lateral extending protrusion, a rear continuous surface, and a pair of longitudinally extending protrusions. The lateral extending protrusion, rear continuous surface, and pair of longitudinally extending protrusions provide contact points and surfaces for rubbing or massaging multiple areas of the animal, particularly suited to massage the head and face area of a cat.

### FIELD OF THE INVENTION

The present invention relates to the field of animal devices, particularly with regard to a device for messaging an animal.

### BACKGROUND

A cat's face is accentuated by his whiskers by emphasizing the muzzle. However, whiskers are more than just facial enhancements, they serve an important function by providing specifically tuned sensory equipment that guide a cat through daily functions. These specialized hairs aid vision and help a cat navigate its environment, providing additional sensory input, much like antennae on insects.

Even though whiskers stem from hair follicles like other hairs, they really stand out on a cat's body. Whiskers are coarser and thicker than regular hair and have roots that are three times deeper. Unlike regular hairs, whiskers don't cover the entire body. They are strategically located above the eyes, on the chin, on the forelegs, near the ears, and above the upper lip. The exact pattern and location of whiskers varies with breed but most cats have approximately twelve whiskers that are arranged in four rows on each opposing cheek.

Whiskers are more sensitive than regular hairs because the follicles from which they originate are highly concentrated with blood vessels and nerves. Although whiskers are called “tactile hairs,” they don't actually feel anything. They simply transmit information to sensory cells when they detect objects or movement. When air flows or an object brushes up against a whisker, the sensitive hair vibrates and stimulates the nerves in the hair follicle. This vibration gives whiskers their scientific name, “vibrissae,” from the Latin word vibrio, meaning “to vibrate.” Detecting subtle changes in air currents, cat whiskers transmit information about the size, shape, and speed of nearby objects, which helps cats navigate the world.

Significantly, the importance of whiskers lies in the fact that they are deeply rooted in follicles, which are surrounded by a muscle tissue or pad that is very rich in nerves and sensory cells. These nerve cells in the roots are then connected to a special area of the cat's brain.

For similar reasons stated above, many cats prefer it when the pad containing nerves and sensory cells at the root of their whiskers are gently touched or rubbed as well as direct stimulation of the whiskers. Further, cats have multiple scent glands on their heads. They have glands located around their mouths, chins, sides of the face, neck and ears. When a cat rubs his face on an item, he leaves their scent behind. Naturally, cats enjoy head and facial stimulation.

The current state of the art fails to teach or suggest an effective device which is specifically designed to gently contact, engage, and stimulate both the pad of nerves located at the root of a cat's whiskers and directly engage the whiskers either simultaneously or independently as desired.

### SUMMARY

In accordance with the invention, a version of the animal massager may generally include an elongated handle having a distal end, a proximal end, a length and an axis formed along the length; and a head portion affixed to the distal end of the elongated handle. In certain versions, the head portion may include a face having a forward extending protrusion terminating at a forward most point; a rear continuous surface opposite of the face; and a pair of protrusions extending upward from the head portion above the face, each protrusion terminating at an outer most point. In a version, the head portion extends offset relative to the axis of the elongated handle.

In a desired version, the face imitates animal facial features including a pair of eyes, a nose, and a mouth, the forward extending protrusion forming a snout including the nose and the mouth.

In other versions of the application, the elongated handle is tapered along the length thereof, wherein preferably the width of the elongated handle tapers from a greater width at the proximal end to a narrower width at the distal end.

In yet another version of the application, the outer most points of the pair of protrusions are positioned radially offset of the axis of the elongated handle.

In a version, the radial distance of the forward most point of the forward extending protrusion from the axis of the elongated handle is greater than the radial distance of each of the outer most points of the pair of protrusions from the axis of the elongated handle.

In yet another alternative embodiment, an animal massager for stimulating a facial whisker pad of a feline is provided. In the embodiment, the animal massager may include an elongated handle having a distal end, a proximal end, a length and an axis formed along the length; and a head portion affixed to the distal end of the elongated handle. The head portion may include a face having a forward extending protrusion forming a snout having a forward most point; a rear continuous surface opposite of the face; and a pair of protrusions extending upward from the head portion above the face, each protrusion terminating at an outer most point, wherein the distance between the outer most point of each protrusion is approximately 15%-25% of the height of the feline facial whisker pad.

These and other features of the present invention will become readily apparent upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a left-side perspective view showing a version of the application;

FIG. 2 is a right-side elevation view of the version shown in FIG. 1;

FIG. 3 is a left-side elevation view of the version shown in FIG. 1;

FIG. 4 is a rear elevation view of the version shown in FIG. 1;

FIG. 5 is a front elevation view of the version shown in FIG. 1;

FIG. 6 is an up-close left-side view of the head portion of the version shown in FIG. 1;

FIG. 7 is an up-close front view of the head portion of the version shown in FIG. 1;

FIG. 8 is an up-close rear view of the head portion of the version shown in FIG. 1;

FIG. 9 is an up-close left-side view of the head portion of the version shown in FIG. 1;

FIG. 10 is a left-side perspective view showing a version of the application;

FIG. 11 is a left-side perspective view showing a version of the application providing an indeterminate length;

FIG. 12 is illustrative example of a cat whisker pattern and surrounding tissue; and

FIG. 13 is a second illustrative example of a cat whisker pattern and surrounding tissue shown without the whiskers.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices and methods are omitted so as not to obscure the description of the present invention with unnecessary detail.

The following detailed description is of the best currently contemplated modes of carrying out exemplary versions of the invention. The description is not to be taken in the limiting sense, but is made merely for the purpose illustrating the general principles of the invention, since the scope of the invention is best defined by the appended claims. Various inventive features are described below that can each be used independently of one another or in combination with other features.

Referring now to the figures wherein the showings are for purposes of illustrating a preferred version of the invention only and not for purposes of limiting the same, the present application discloses an animal massager otherwise a device for stimulating a pet animal, such as a house cat. In a particular version, the animal massager is ideally suited to gently engage, massage, and stimulate cat whiskers and the surrounding tissue located at the base of the whiskers by contacting the animal with one or more protrusions and surfaces.

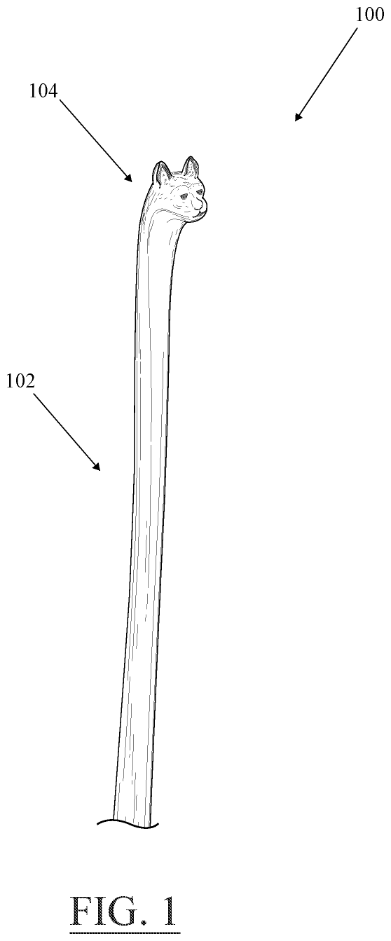

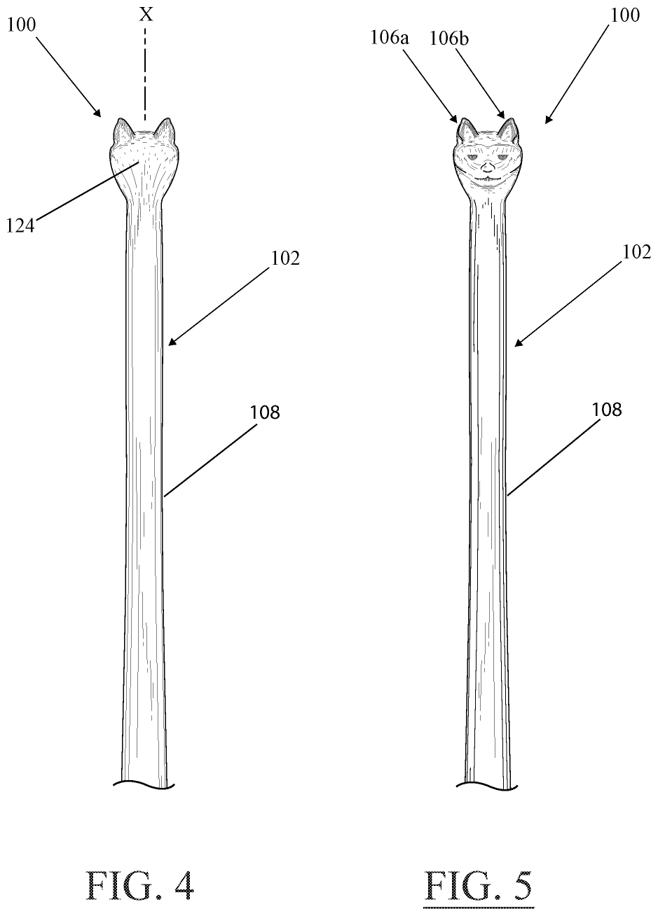

Referring generally to FIG. 1-FIG. 10, a version of the animal massager is described for engaging, massaging, and interacting with a pet animal in order to provide enjoyment and interaction between the pet animal and the pet owner. As shown, the animal massager 100 generally comprises an elongated handle 102 and a head portion 104 affixed to an end of the elongated handle 102. Generally, the head portion 104 comprises a lateral extending protrusion 120, a rear continuous surface 124, and a pair of longitudinally extending protrusions 106a, 106b. The lateral extending protrusion 120, rear continuous surface 124, and pair of longitudinally extending protrusions 106a, 106b provide contact points/surfaces for rubbing or massaging multiple areas of the pet, particularly configured to massage the head and face area of a cat.

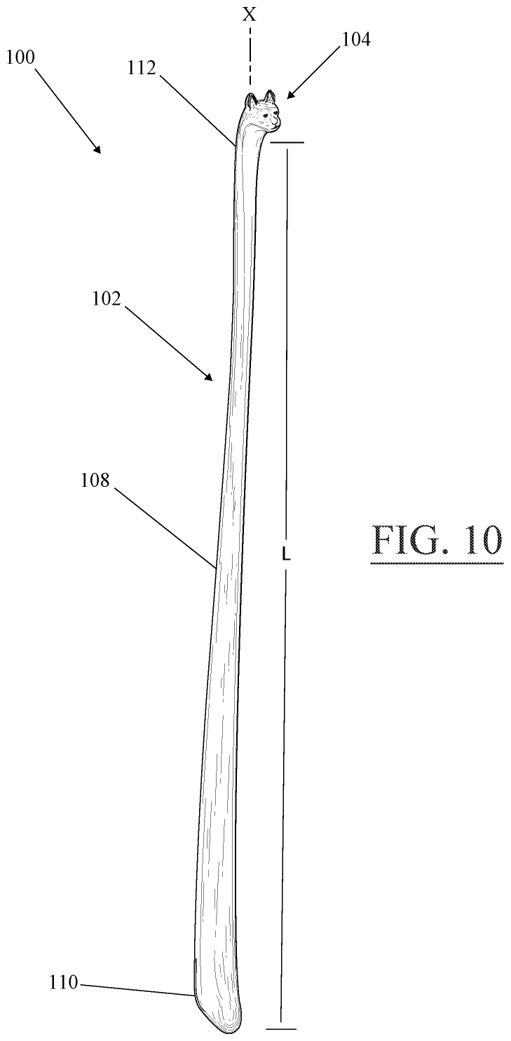

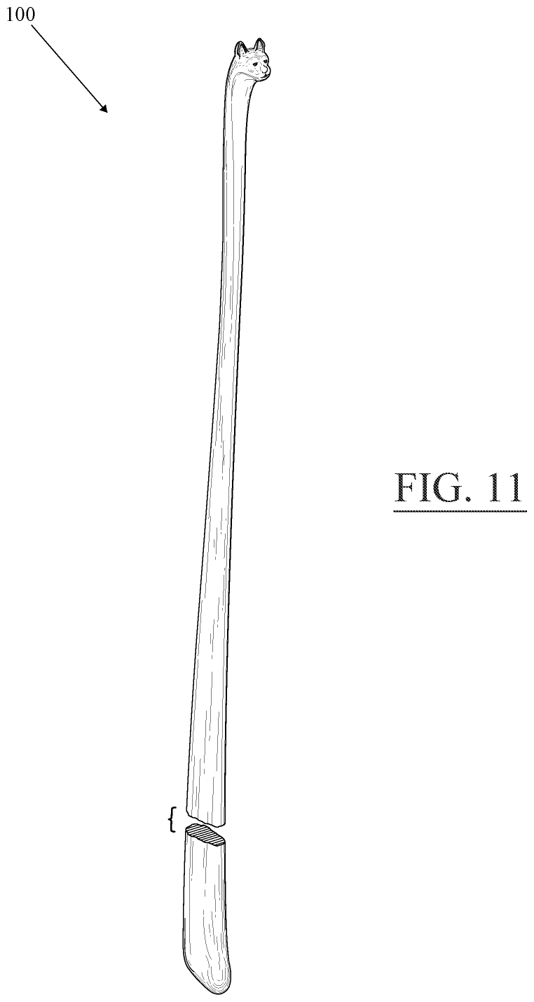

With reference to FIG. 10 and FIG. 11, the elongated handle 102 functions to support the head portion 104 throughout engagement of the animal massager 100 with the pet animal. The elongated handle 102 provides a body 108 having a length L and axis X which extends between a proximal end 110 and a distal end 112. The proximal end 110 of the elongated handle 102 is generally enlarged or larger than the distal end 112 because it designed to be grasped by the operator's hand. The distal end 112 of the elongated handle 102 functions to interconnect and fixedly support the head portion 104.

Preferably, the length L of the elongated handle 102 is at least 15 centimeters in length. More preferably, the length L of the elongated handle 102 is approximately between 15-30 centimeters. The preferable range of the length L of the elongated handle is well suited to accommodate different degrees of user mobility. For example, lengths over 15 centimeters have been found to be adequate for people with limited mobility due to a handicap or age limitations.

In the illustrated version, the elongated handle 102 is generally tapered, wherein the width narrows from the proximal end 110 having greater width to the distal end 112 having a narrower width. However, the width along the length of the elongated handle 102 may be linear or irregular in nature. Moreover, the cross-section of the elongated handle 102 may define various shapes and sizes including, but not limited to a square, rectangle, circular, oval, polygonal, etc. Preferably, the greatest width of the proximal end 110 of the elongated handle 102 is approximately between 10-15 millimeters and the width of the distal end 112 is approximately between 5-10 millimeters. Other sizes may be desired to suit unique applications, for example, a larger proximal end 110 may be needed to accommodate arthritic hands.

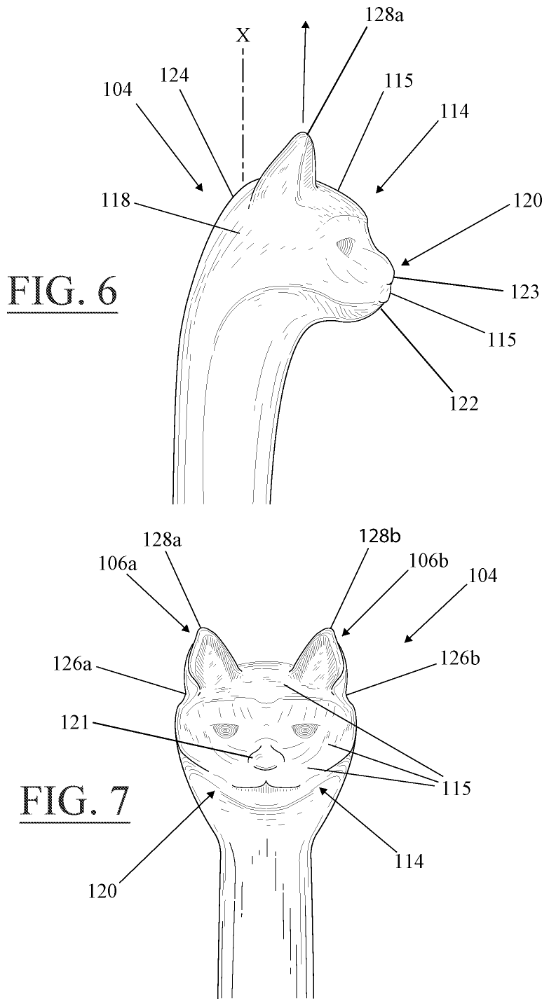

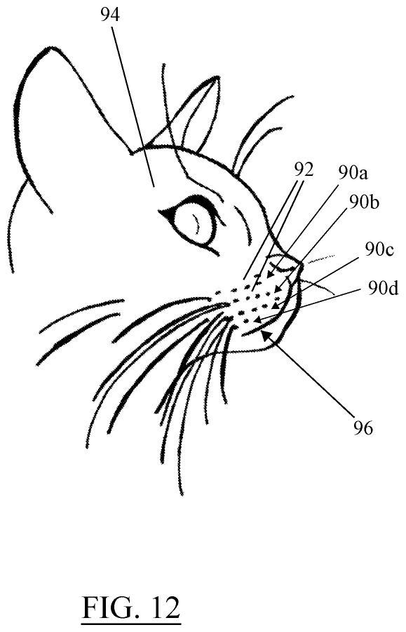

With reference to FIG. 12, as previously described, the exact pattern and location of whiskers varies with breed but most cats have twelve whiskers that are arranged in four rows on each cheek. The whiskers are deeply rooted in follicles, which are surrounded by a muscle tissue or pad that is very rich in nerves and sensory cells. The head portion 104 functions to engage and stimulate the pet animal in a positive and rewarding manner. As best shown in FIG. 6-FIG. 9, the head portion 104 generally integrally and fixedly attaches to the distal end 112 of the elongated handle 102. In a specific application, the head portion 104 is designed to primarily engage the rows of feline whiskers 90a-90d that are found on the upper lip and opposing cheeks thereof (See FIG. 12). However, the head portion 104 can certainly be utilized to stimulate other areas of a cat or other types of animals. For example, the user may utilize the head portion 104 to massage the area between a cat's eyebrow and ear which is known to have a small sensitive indent.

As best shown in FIG. 6-FIG. 9, a version of the head portion 104 generally comprises a rounded face 114 which imitates animal facial features. The face 114 having a plurality of curved surfaces 115 forming a forward or laterally extending protrusion 120 or snout terminating at a forward most point 123—and a rear continuous surface 124 positioned opposite of the animal face 114. Further, the head portion comprises a pair of protrusions 106a, 106b longitudinally extending upward from the top of the head portion 104. The pair of protrusions 106a, 106b may further function to imitate animal ears positioned above the animal face 114.

Generally, the function of the head portion 104 is three-fold. First, the pair of protrusions 106a, 106b function to simultaneously stimulate the tissue or pad 92 surrounding each row of whiskers 90a-90d (See FIG. 12), thereby bridging over the row of whiskers and stimulating the opposing tissue or pad 92. Second, the rounded face 114 and forward extending protrusion 120 forming a snout provides the ability to gently stimulate a length of one or more whiskers. Third, the rear continuous surface 124 is utilized to stimulate or caress other areas of the animal, such as the area 94 between a cat's eyebrows and respective ear. Thus, the animal massager 100 provides the operator the ability to stimulate independently or simultaneously the pad containing the whisker follicles and/or the length of whiskers as well as other areas.

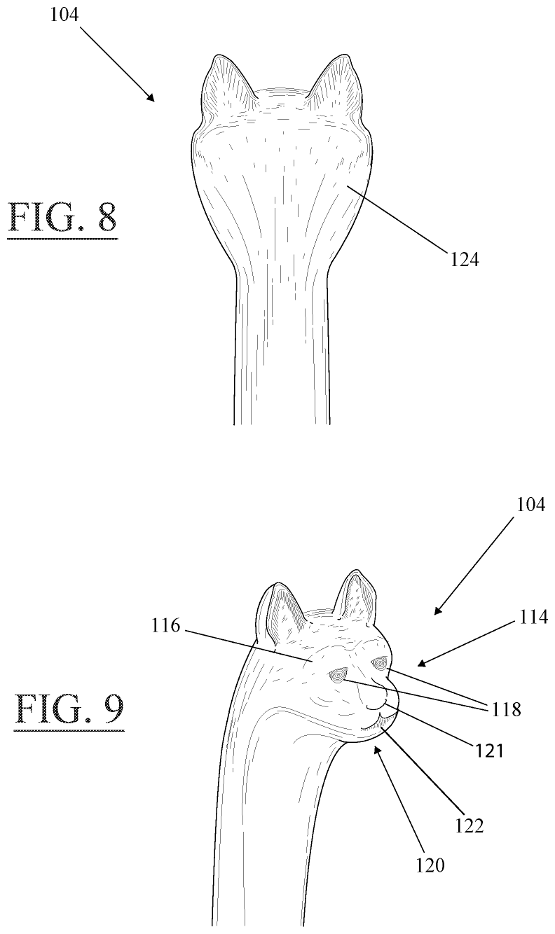

Preferably as best shown in FIG. 9, the facial features of the rounded animal face 114 may comprise brows 116, a pair of eyes 118, a forward or laterally extending protrusion 120 forming a snout having a nose 121 and a mouth portion 122. The combination of the facial features both imitate an animal's face, for example a cat as illustrated, as well as provide a variably rounded, smooth curved surfaces 115 for engaging the whiskers of the animal directly. In certain embodiments, the head portion 104 may include a curved rear continuous surface 124 forming an additional surface for providing stimulation to the cat whiskers or other area (See FIG. 6 and FIG. 8). In certain version, the forward extending protrusion terminating at the forward most point 123 is radially positioned at least 8 millimeters, preferably approximately between 8-18 millimeters, from the elongated handle 102 axis X.

With reference to FIG. 6-FIG. 8, the pair of protrusions 106a, 106b extend upward and outward from the head portion 104, preferably above the animal face 114 thereby imitating a pair of ears while providing two points of stimulation. Preferably, the pair of protrusions 106a, 106b extend in the same general direction along the length or axis X of the elongated handle 102. In other terms, the pair of protrusions 106a, 106b are positioned to ideally transfer an axial force or load that is applied to the elongated handle 102 along the length or perpendicular to the cross section thereof (along the axial direction). Thus, during use of the animal massager 100, the operator can use the elongated handle 102 to impart a gentle prodding movement to the pair of protrusions 106a, 106b.

As shown in FIG. 7, each of the protrusions 106a, 106b extend upward from a base 126a, 126b and narrow towards and terminate at an outer most point 128a, 128b. Preferably, the height of each protrusion between its base 126a, 126b and the outer most point 128a, 128b is equal to the other. Thus, the pair of protrusions 106a, 106b are preferably mirrored. In certain versions, the height of each of the protrusions 106a, 106b ranges from 1.5-4 millimeters. Ideally, the height of each of the protrusions 106a, 106b is 3-4 millimeters to provide adequate penetration into the feline whisker nerves, thereby maximizing stimulation. Minimally, the height of each of the protrusions 106a, 106b is at least 1 millimeter in order to function in a basic manner. Preferably, the outer most points 128a, 128b is smooth and rounded, therefore during operation the points will not cause pain to the animal.

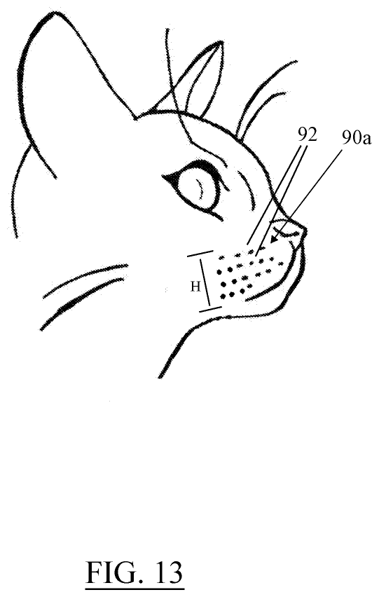

As it relates to the stimulation of the feline whiskers and surrounding pad, it is preferable that the pair of protrusions 106a, 106b outer most points 128a, 128b are positioned apart from the other by approximately 15%-25% of the height of a relevant cat's entire facial whisker pad 92 (See FIG. 13). Thus, the larger the cat, the larger the desired distance between the outer most points 128a, 128b. This type of configuration allows each protrusion 106a, 106b to simultaneously stimulate the surrounding area of the pad 92 shortly above or below a row of whiskers 90a. As it relates to the specific application of a standard sized house cat, it is desirable that the distance between the outer most points 128a, 128b is between 3-10 millimeters, more preferably, between 4-8 millimeters.

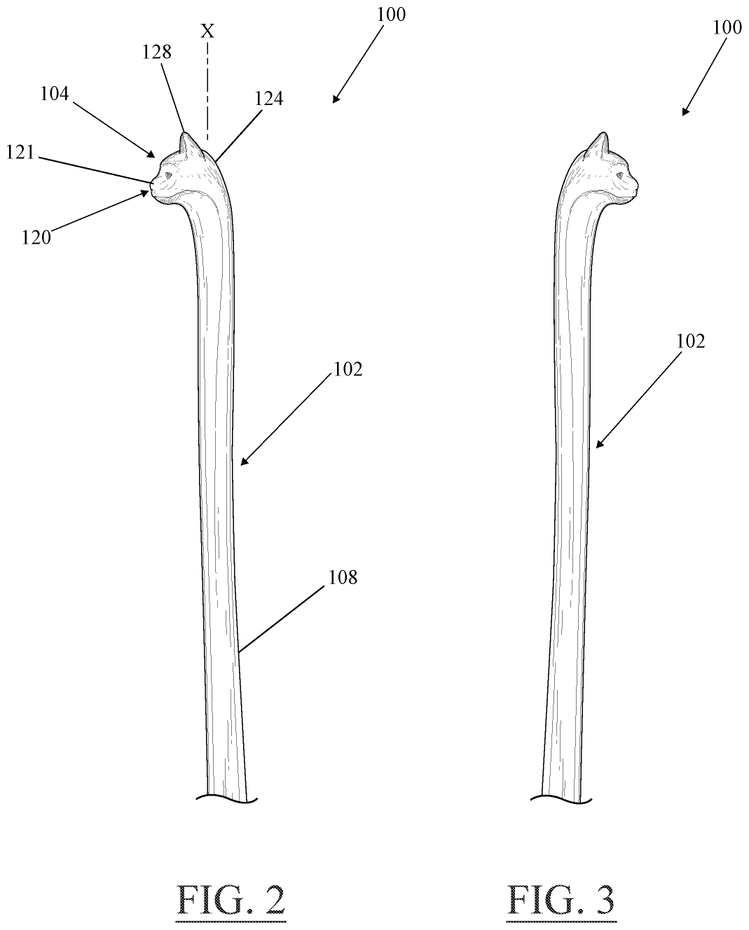

As best shown in FIG. 2, in certain versions of the application, the head portion 104 extends outward and offset from the distal end 112 of the elongated handle and the elongated handle 102 longitudinal axis X. As such, the orientation positions each of the outer most points 128a, 128b of the respective protrusions 106a, 106b offset of the elongated handle and longitudinal axis X. Therefore, in certain versions of the application, the outer most points 128a, 128b of the pair of protrusions 106a, 106b are positioned radially offset of the axis X of the elongated handle (See FIG. 6). Preferably, the radial distance of the outer most points 128a, 128b of each of the protrusions from the axis of the elongated handle is at least 2 millimeters, preferably between 2-8 millimeters.

Further, and as best shown in FIG. 6, in certain versions of the application, it may be preferable that the radial distance of the forward most point 123 of the laterally extending protrusion 120 from the axis X of the elongated handle 102 is greater than the radial distance of each of the outer most points 128a, 128b of the pair of protrusions 106a, 106b from the axis X of the elongated handle 102.

A method utilizing the animal massager 100 will now be described as it applies to cat whisker patterns as shown in FIG. 12. The cat whisker pattern shown in FIG. 12 illustrates how a typical house cat has four rows of whiskers 90a-90d, wherein the surrounding areas around and between each row of whiskers 90a-90d forms an overall pad 92 which contain the whisker follicles and concentration of nerves. Firstly, in order to prepare the cat for a massage session with the animal massager 100, calming techniques may be utilized, for example, by petting the cat and/or making familiar noises towards the cat. The calming techniques are desired in order to assure that the cat is in a receptive state of mind and not agitated prior to making contact therewith.

Thereafter, the animal massager 100 is held by the operator near the proximal end 110 of the elongated handle 102 as if holding a stick or other elongated object. Once the animal massager 100 is properly held by the operator, the animal massager 100 can be manipulated in several primary directions, namely, axially forward and backward (gentle prodding), laterally from side to side or from top to bottom, and/or rotate in a clockwise or counterclockwise direction. Once the user has established that the animal is in a receptive state of mind, the operator gently pushes the animal massager 100 forward towards the feline whisker area, gently engaging and contacting the pads surrounding the whiskers 90a-90d with one or both of the pair of protrusions 106a, 106b. The operator may adjust the amount of pressure applied by gauging how the animal is responding, whether in a positive or a negative way. Thereafter, the operator may independently or simultaneously engage the whiskers 90a-90b of the animal directly by utilizing the plurality of curved surfaces 115, the laterally extending protrusion 120 or the rear continuous surface 124 of the head portion 104, gently rotating the animal massager 100 by rotating the elongated handle 102 by the operator's hand movement.

The operator is free to decide what movements and what level of pressure to utilize to maximize or minimize the enjoyment level of the animal. Often, once the cat has been stimulated by the animal massager 100, the cat will aggressively self-message or apply its own pressure towards the head portion 104. Thereafter the animal massager only needs to be pointed at that cat and held firmly in order for the cat to massage itself as it sees fit. Many times, the cats enjoy the massage so much that it's difficult for the user to maintain the animal massager 100 throughout the massage sessions due to the force of the cat upon the head portion 104—two hands may be required for operation.

Further, the user may utilize the rear continuous surface 124 to massage the cat, particularly in the area 94 between each eyebrow and respective ear. It is known that cats have a small dip in front of each ear and, when calm, enjoy this area being lightly rubbed by the rear continuous surface 124.

The animal massager 100 can be made in any manner and of any material chosen with sound engineering judgment. Preferably, materials will be strong, lightweight, long lasting, economic, ergonomic, and buoyant. Ideally, the animal massager 100 is manufactured of plastic, metal, and/or wood or a combination thereof. Preferably, the animal massager 100 is manufactured of a wood material because it naturally absorbs animal scents or can facilitate to absorb materials such as Nepeta cataria commonly known as catnip.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

What is claimed is:

1. An animal massager comprising:
an elongated handle having a distal end, a proximal end, a length and an axis formed along the length; and
a head portion affixed to the distal end of the elongated handle, the head portion comprising:
a face having a forward extending protrusion terminating at a forward most point;
a rear continuous surface opposite of the face; and
a pair of protrusions extending upward from the head portion above the face, each protrusion terminating at an outer most point.

2. The animal massager of claim 1, wherein the head portion extends offset relative to the axis of the elongated handle.

3. The animal massager of claim 1, wherein the distance between the outer most point of each protrusion is between 3-10 millimeters.

4. The animal massager of claim 1, wherein the distance between the outer most point of each protrusion is between 4-8 millimeters.

5. The animal massager of claim 1, wherein the height of each of the protrusion is between 1.5-4 millimeters.

6. The animal massager of claim 5, wherein the height of each of the protrusions is equal to the other.

7. The animal massager of claim 5, wherein the elongated handle has a length that is at least 15 centimeters.

8. The animal massager of claim 7, wherein the length of the elongated handle is between approximately 15-30 centimeters.

9. The animal massager of claim 8, wherein the width of the elongated handle is tapered along the length thereof.

10. The animal massager of claim 9, wherein the width of the elongated handle tapers from a greater width at the proximal end to a narrower width at the distal end.

11. The animal massager of claim 10, wherein the width of the proximal end of the elongated handle is approximately 10-15 millimeters and the width of the distal end is 5-10 millimeters.

12. The animal massager of claim 5, wherein the outer most points of the pair of protrusions are positioned radially offset of the axis of the elongated handle.

13. The animal massager of claim 12, wherein the radial distance of the outer most points of each of the protrusions from the axis of the elongated handle is at least 2 millimeters.

14. The animal massager of claim 12, wherein the radial distance of the forward most point of the forward extending protrusion from the axis of the elongated handle is greater than the radial distance of each of the outer most points of the pair of protrusions from the axis of the elongated handle.

15. The animal massager of claim 1, wherein the outer most points of the pair of protrusions are positioned radially offset of the axis of the elongated handle.

16. The animal massager of claim 15, wherein the radial distance of each of the outer most points of the pair of protrusions from the axis of the elongated handle is between 2-8 millimeters.

17. The animal massager of claim 16, wherein the radial distance of the forward most point of the forward extending protrusion from the axis of the elongated handle is greater than the radial distance of each of the outer most points of the pair of protrusions from the axis of the elongated handle.

18. The animal massager of claim 1, wherein the face imitates animal facial features including a pair of eyes, a nose, and a mouth, the forward extending protrusion forming a snout including the nose and the mouth.

19. The animal massager of claim 1, wherein the animal massager is manufactured of a wood material.

20. An animal massager for stimulating a facial whisker pad of a feline, the animal massager comprising:
an elongated handle having a distal end, a proximal end, a length and an axis formed along the length; and
a head portion affixed to the distal end of the elongated handle, the head portion comprising:
a face having a forward extending protrusion forming a snout having a forward most point;
a rear continuous surface opposite of the face; and
a pair of protrusions extending upward from the head portion above the face, each protrusion terminating at an outer most point, wherein the distance between the outer most point of each protrusion is approximately 15%-25% of the height of the feline facial whisker pad.

21. The animal massager of claim 20, wherein the height of each of the protrusion is between 1.5-4 millimeters.

22. The animal massager of claim 21, wherein the elongated handle has a length that is at least 15 centimeters.
